(19) United States
(12) Patent Application Publication
(10) Pub. No.: US 2025/0296650 A1
(43) Pub. Date: Sep. 25, 2025

(54) WINDSCREEN DEVICE

(71) Applicant: HONDA MOTOR CO., LTD., Tokyo (JP)

(72) Inventors: Yoichi Nishida, Tokyo (JP); Kohei Hirano, Tokyo (JP)

(21) Appl. No.: 19/077,094

(22) Filed: Mar. 12, 2025

(30) Foreign Application Priority Data
Mar. 19, 2024 (JP) 2024-042969

(51) Int. Cl. B62J 17/04

(52) U.S. Cl. CPC B62J 17/04

(57) ABSTRACT

This windscreen device includes a windscreen, a holder configured to support the windscreen, a bracket configured to vertically movably support the holder together with the windscreen and fixed to a vehicle body, and a shaft extending in a vehicle leftward/rightward direction and configured to pass through and connect first connecting parts of the holder and second connecting parts of the bracket in the vehicle leftward/rightward direction, one of the first connecting parts and the second connecting parts is shaft holding parts configured to relatively immovably hold the shaft when seen in the vehicle leftward/rightward direction, the other of the first connecting parts and the second connecting parts is slide groove forming parts that form a slide groove extending in a vehicle upward/downward direction and allow the shaft holding parts to slide in a groove length direction of the slide groove, a height of the windscreen is adjustable together with the holder by sliding the shaft holding parts along the slide groove, the slide groove forming parts are provided with fitting members that are supported by the shaft and able to move integrally with the shaft in the vehicle leftward/rightward direction, and fitting concave portions that partially expand lateral grooves and allow the fitting members to fit are formed at a plurality of places at intervals in the groove length direction of the slide groove, the fitting members and the fitting concave portions constitute lock actuating parts configured to switch between a locked state in which the shaft holding parts are unable to slide with respect to the slide groove forming parts and a lock released state in which the shaft holding parts are able to slide with respect to the slide groove forming parts, the shaft is provided with an operating part configured to move the shaft and the fitting members in the vehicle leftward/rightward direction and switch between the locked state and the lock released state of the lock actuating parts, and the operating part is provided only on one side of the shaft in the vehicle leftward/rightward direction.

### CROSS-REFERENCE TO RELATED APPLICATION

The present application claims priority based on Japanese Patent Application No. 2024-042969, filed Mar. 19, 2024, the content of which is incorporated herein by reference.

### BACKGROUND OF THE INVENTION

### Field of the Invention

The present invention relates to a windscreen device.

### Description of Related Art

In the related art, there is known a windscreen device including a windscreen that rises in front of a boarding position and a screen support mechanism that allows the windscreen to be manually raised and lowered (for example, see Japanese Unexamined Patent Application, First Publication No. 2023-007195, Japanese Patent No. 7194262).

### SUMMARY OF THE INVENTION

Incidentally, in the configuration in the related art, operating parts configured to release a lock of a height adjustment of the windscreen are provided on both left and right sides of the screen support mechanism. When the lock of the height adjustment of the windscreen is released, a user needs to simultaneously perform outward pull operations in a leftward/rightward direction on both the left and right operating parts. For this reason, when adjusting the height of the windscreen, the user needs to use both hands to perform the operation, so there is a demand for a configuration that makes it easier to adjust the height of the windscreen.

An aspect of the present invention is directed to providing a windscreen device capable of performing height adjustment of a windscreen with one hand.

In order to accomplish the above-mentioned purposes, a windscreen device according to an aspect of the present invention employs the following configurations.
(1) An aspect of the present invention is a windscreen device (30) including: a windscreen (31); a holder (50) configured to support the windscreen (31); a bracket (40) configured to vertically movably support the holder (50) together with the windscreen (31) and fixed to a vehicle body; and a shaft (53) extending in a vehicle leftward/rightward direction and configured to pass through and connect first connecting parts (54L, 54R) of the holder (50) and second connecting parts (42L, 42R) of the bracket (40) in the vehicle leftward/rightward direction, wherein one of the first connecting parts (54L, 54R) and the second connecting parts (42L, 42R) is shaft holding parts (54L, 54R) configured to relatively immovably hold the shaft (53) when seen in the vehicle leftward/rightward direction, the other of the first connecting parts (54L, 54R) and the second connecting parts (42L, 42R) is slide groove forming parts (42L, 42R) that form a slide groove (42a) extending in a vehicle upward/downward direction and allow the shaft holding parts (54L, 54R) to slide in a groove length direction of the slide groove (42a), a height of the windscreen (31) is adjustable together with the holder (50) by sliding the shaft holding parts (54L, 54R) along the slide groove (42a), the slide groove forming parts (42L, 42R) are provided with fitting members (46L, 46R) that are supported by the shaft (53) and able to move integrally with the shaft (53) in the vehicle leftward/rightward direction, and fitting concave portions (45L, 45R) that partially expand lateral grooves and allow the fitting members (46L, 46R) to fit are formed at a plurality of places at intervals in the groove length direction of the slide groove (42a), the fitting members (46L, 46R) and the fitting concave portions (45L, 45R) constitute lock actuating parts (47L, 47R) configured to switch between a locked state (S1) in which the shaft holding parts (54L, 54R) are unable to slide with respect to the slide groove forming parts (42L, 42R) and a lock released state (S2) in which the shaft holding parts (54L, 54R) are able to slide with respect to the slide groove forming parts (42L, 42R), the shaft (53) is provided with an operating part (65) configured to move the shaft (53) and the fitting members (46L, 46R) in the vehicle leftward/rightward direction and switch between the locked state (S1) and the lock released state (S2) of the lock actuating parts (47L, 47R), and the operating part (65) is provided only on one side of the shaft (53) in the vehicle leftward/rightward direction.

According to the aspect of the above-mentioned (1), by providing the operating part that switches between locking and unlocking of the lock actuating part only on one side of the shaft in the vehicle leftward/rightward direction, which connects the holder that supports the windscreen to the bracket that is fixed to the vehicle body, the occupant (user) can adjust the height of the windscreen with one hand. For this reason, compared to switching between the locking and unlocking of the lock actuating part by using the operating parts on both the left and right sides, this makes it easier to operate the height adjustment and achieves reduction in the number of parts.
(2) In the aspect of the above-mentioned (1), the lock actuating parts (47L, 47R) may be provided in pairs on the left and right, and the operating part (65) on one side of the left and right may be able to switch states of a pair of left and right lock actuating parts (47L, 47R) simultaneously.

According to the aspect of the above-mentioned (2), by simultaneously switching the locking and unlocking of the pair of left and right lock actuating parts by operating only one of the operating parts in the leftward/rightward direction of the vehicle, it is possible to perform stable windscreen height adjustments using the pair of left and right lock actuating parts while also performing windscreen height adjustments with one hand.
(3) In the aspect of the above-mentioned (1), the lock actuating parts (47L, 47R) may move the fitting members (46L, 46R) to the other side in the vehicle leftward/rightward direction to enter the locked state (S1), and move the fitting members (46L, 46R) to one side in the vehicle leftward/rightward direction to enter the lock released state (S2), and the fitting members (46L, 46R) may be biased toward the other side in the vehicle leftward/rightward direction by an elastic member (57).

According to the aspect of the above-mentioned (3), as the fitting member of the lock actuating part is biased toward the other side (lock side) in the vehicle leftward/rightward direction by the elastic member, after operation of the operating part to one side (unlock side) in the vehicle leftward/rightward direction to perform the screen height adjustment, the lock actuating part can be returned to the locked state by simply releasing the operating part, making it easier to adjust the windscreen height.
(4) In the aspect of the above-mentioned (1), at least one of a first fitting surface (46b) fitted into the fitting concave portions (45L, 45R) in the fitting members (46L, 46R) and a second fitting surface (45b) fitted onto the fitting members (46L, 46R) in the fitting concave portions (45L, 45R) may become tapered surfaces (45b, 46b) that reduce a cross-sectional shape size as they go toward the other side in the vehicle leftward/rightward direction.

According to the aspect of the above-mentioned (4), at least one of the fitting surfaces of the fitting member and the fitting concave portion is a tapered surface, so that even if the relative positions of the fitting member and the fitting concave portion are slightly misaligned, the tapered surface can guide the fitting member and the fitting concave portion to the prescribed relative position. In addition, when the fitting member is biased in the fitting direction, the wedge effect of the tapered surface allows the fitting member and the fitting concave portion to be securely fitted together without rattling even with limited biasing force. For this reason, the screen height adjustment can be further facilitated.
(5) In the aspect of the above-mentioned (1), the operating part (65) may include a grip portion (68) that extends rearward from the shaft (53) when seen in an axial direction of the shaft (53).

According to the aspect of the above-mentioned (5), by providing the operating part with the grip portion that extends rearward beyond the shaft, the grip portion can be easily seen from the rear (occupant side) of the operating part and the grip portion can be easily reached, thereby improving the operability of the operating part.
(6) In the aspect of the above-mentioned (1), the operating part (65) may include a grip portion (68) offset outward in the vehicle leftward/rightward direction with respect to a base portion (66) configured to fix an end portion of the shaft (53).

According to the aspect of the above-mentioned (6), by providing the operating part with the grip portion that is offset further outward in the vehicle leftward/rightward direction than the end portion of the shaft, it is easier to ensure clearance for the hand to reach inside the grip portion in the vehicle leftward/rightward direction regardless of the position of the end portion of the shaft in the vehicle leftward/rightward direction, thereby improving the operability of the operating part.
(7) In the aspect of the above-mentioned (1), the lock actuating parts (47L, 47R) may have a rotation restriction structure (48) configured to restrict rotation of the operating part (65) about the shaft (53) in the locked state (S1).

According to the aspect of the above-mentioned (7), by having the rotation restriction structure in which the lock actuating part restricts the rotation angle of the operating part in the locked state, the rotation angle of the operating part after the screen height adjustment (locked state) can be adjusted to a preset desired angle. For this reason, after the screen height adjustment, the operating part can be maintained at a comfortable angle.

According to the aspect of the present invention, it is possible to provide a windscreen device capable of performing height adjustment of a windscreen with one hand.

### BRIEF DESCRIPTION OF THE DRAWINGS

FIG. 1 is a left side view of a motorcycle according to an embodiment of the present invention.

FIG. 2 is a front view (front surface view) of surroundings of a windscreen of the motorcycle.

FIG. 3 is a left side view of surroundings of the windscreen.

FIG. 4 is a left side view when the windscreen is located at a lower limit position.

FIG. 5 is a left side view when the windscreen is located at an upper limit position.

FIG. 6(A) is a cross-sectional view along line VI-VI in FIG. 4, and FIG. 6(B) is a cross-sectional view of line B-B in FIG. 6(A).

FIG. 7 is the same cross-sectional view as FIG. 6(A).

FIG. 8 is a perspective view of a screen support mechanism.

FIG. 9 is a left side view showing a structure for removing rattling in a rotation direction of an operating part of the screen support mechanism.

### DESCRIPTION OF EMBODIMENTS

Hereinafter, an embodiment of the present invention will be described with reference to the accompanying drawings. Further, directions of forward, rearward, leftward, rightward, and the like, in the following description are the same as directions in a vehicle described below unless the context indicates otherwise. In addition, in appropriate places used in the following description, an arrow FR indicates the forward direction of the vehicle, an arrow LH indicates the leftward direction of the vehicle, an arrow UP indicates the upward direction of the vehicle, and a line CL indicates a lateral center of a vehicle body.

### Entire Vehicle

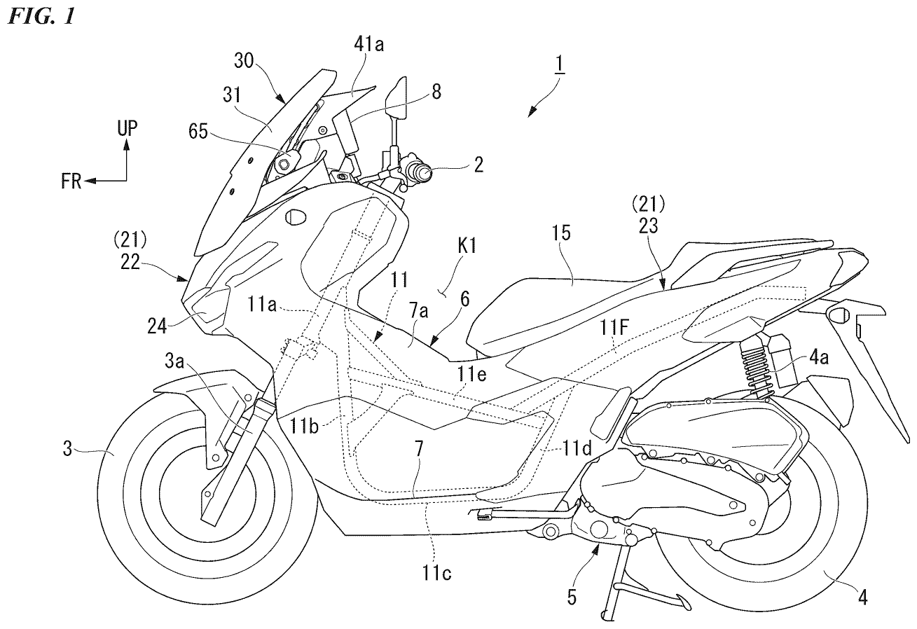

FIG. 1 shows a scooter type motorcycle (saddle riding vehicle) 1 as an example of a saddle riding vehicle of the embodiment.

The motorcycle 1 includes a front wheel 3 that is a steered wheel, and a rear wheel 4 that is a driving wheel. The front wheel 3 is supported by front forks 3a, and steerable by a bar handle 2. The rear wheel 4 is supported by, for example, a swing type power unit 5 and can be driven by the power unit 5. The swing type power unit 5 is provided integrally with a prime mover such as an internal combustion engine, an electric motor, or the like, and a transmission device configured to transmit output of the prime mover to the rear wheel 4.

Steering system parts including the bar handle 2, the front forks 3a and the front wheel 3 are steerably supported by a head pipe 11a of a front end portion of a vehicle body frame 11. A front portion of the swing type power unit 5 is vertically swingably supported by a longitudinal intermediate portion of the vehicle body frame 11. A rear portion of the power unit 5 is supported by a rear portion of the vehicle body frame 11 via a rear cushion 4a. Further, the term “intermediate” in the embodiment is not limited to “a center.”

In the embodiment, while the telescopic front forks 3a have been exemplified as a front wheel suspension device of the motorcycle 1, there is no limitation to this configuration. For example, the front wheel suspension device may be a link type using a swing arm, or other types.

The motorcycle 1 is not limited to the unit swing type vehicle as described above, and it may be a vehicle in which the prime mover is fixedly mounted on the vehicle body frame 11.

A seat 15 on which an occupant sits is disposed behind the bar handle 2. A low floor section 6 of the vehicle body is provided between the bar handle 2 and the seat 15. A crossing space K1 is formed above the low floor section 6 to allow an occupant to easily straddle the vehicle body. The low floor section 6 includes a pair of left and right floor steps 7 on which a driver sitting on the seat 15 places his/her left and right legs, and a center tunnel 7a extending in a vehicle forward/rearward direction between the left and right floor steps 7.

### Vehicle Body Frame 11

Referring to FIG. 1, the vehicle body frame 11 includes the head pipe 11a, a down frame 11b extending downward and rearward from the head pipe 11a, a lower frame 11c extending rearward from a lower end portion of the down frame 11b, a center frame 11d extending rearward and upward from a rear end portion of the lower frame 11c, a middle frame 11e bridging between the down frame 11b and the center frame 11d, and a rear frame 11f having a front end connected to a rear upper side of the middle frame 11e and extending rearward and upward from the front end.

An upper end of the center frame 11d is connected to a front lower side of the rear frame 11f. The down frame 11b, the lower frame 11c and the center frame 11d constitute an integrated frame member that is continuous via bent portions. The down frame 11b, the lower frame 11c and the center frame 11d, as well as the middle frame 11e and the rear frame 11f, are provided on both left and right sides of the vehicle body, forming a left and right pair.

### Vehicle Body Cover 21

Surroundings of the vehicle body frame 11 are covered with a vehicle body cover 21. The vehicle body cover 21 includes the left and right floor steps 7 and the center tunnel 7a, a front body cover 22 continuous with front sides of the left and right floor steps 7 and the center tunnel 7a, and a rear body cover 23 continuous with rear sides of the left and right floor steps 7 and the center tunnel 7a.

An article accommodating box (not shown) is disposed inside the rear body cover 23. The article accommodating box has a container shape that opens upward. The upper opening of the article accommodating box can be opened and closed by pivoting the seat 15 via a hinge (not shown) on a front end side.

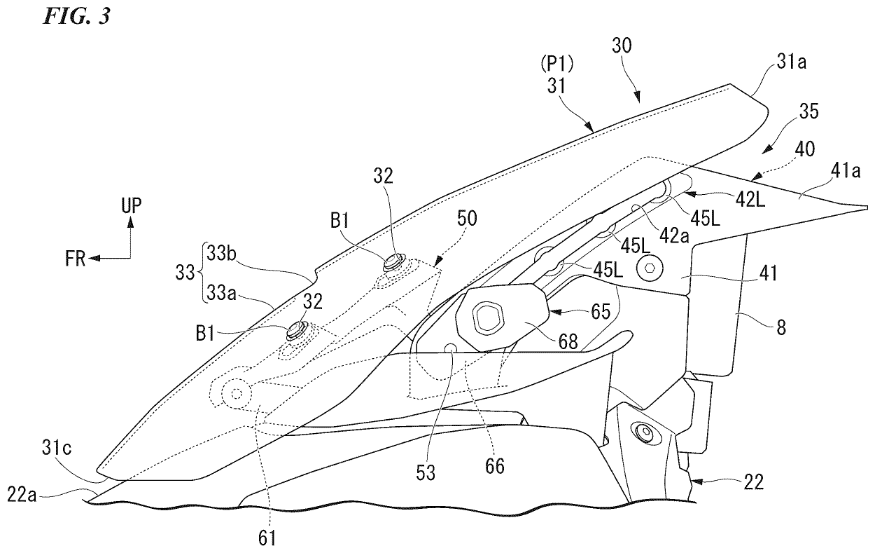

Referring also to FIG. 3, a windscreen 31 rising in front of a boarding position of the motorcycle 1 is disposed in front of and above the front body cover 22. The windscreen 31 is supported by the vehicle body including the front body cover 22, a cover support frame (not shown), and the like, via a screen support mechanism 35. The windscreen 31 (screen main body) and the screen support mechanism 35 are included in a windscreen device 30 of the motorcycle 1.

### Windscreen Device 30

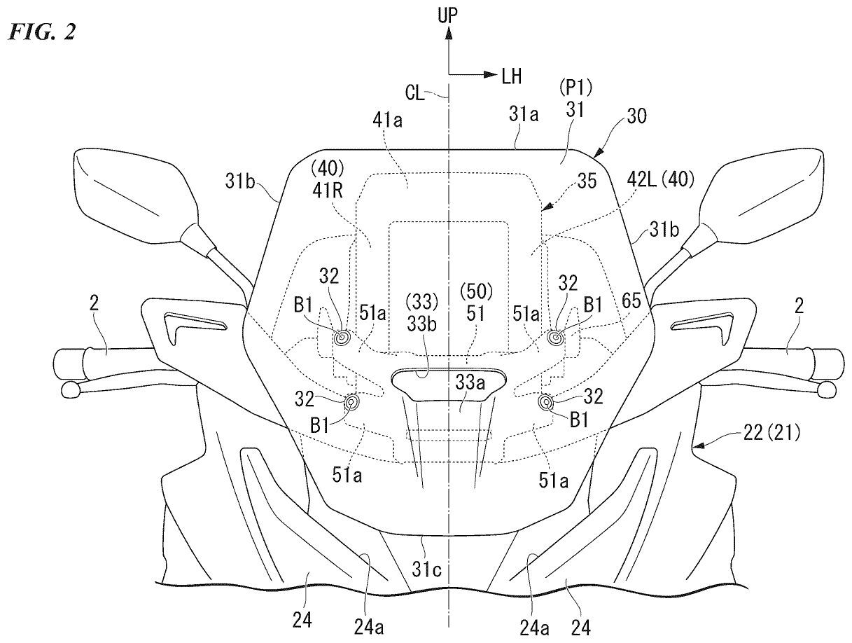

FIG. 2 is a front view (front surface view) of surroundings of the windscreen 31, and FIG. 3 is a left side view of surroundings of the windscreen 31.

Referring to FIG. 1 to FIG. 3, the windscreen 31 extends to rise upward and rearward from the side of a lower end portion in front of the boarding position where a driver performs driving of the motorcycle 1. The windscreen 31 extends to be obliquely inclined upward and rearward from the side of the lower end portion when seen in a side view. The windscreen 31 can be raised or lowered by actuating the screen support mechanism 35 (movable mechanism) with a manual operation.

A lower portion of the windscreen 31 is fixed to a holder 50 of the screen support mechanism 35. The holder 50 is supported by a bracket 40 of the screen support mechanism 35 fixed to a vehicle body to be vertically raised or lowered. The screen support mechanism 35 includes an operating part 65 that enables a manual operation by a driver (occupant, user) on a left side of the vehicle. The screen support mechanism 35 can vertically raise or lower the windscreen 31 by the manual operation to the operating part 65 by the user.

Here, referring also to FIG. 1, a meter device 8 is disposed on an upper portion of the front body cover 22 in front of a handle 2. The meter device 8 functions as a gauge that indicates, for example, a vehicle speed and an engine rotation number. The meter device 8 is separated from, for example, steering system parts and supported by the front body cover 22, a cover support frame (not shown), and the like. The meter device 8 is constituted by, for example, a display device such as a liquid crystal display or the like configured to display various types of information of the motorcycle 1 as images. For example, the meter device 8 is disposed with its rectangular display screen facing rear (toward the driver).

The meter device 8 is supported by a meter support part 41 formed integrally with a rear portion of the bracket 40 of the screen support mechanism 35. A meter visor 41a is formed integrally with the upper portion of the meter support part 41. The meter visor 41a extends rearward from a range crossing upper portions of an upper edge and left and right side edges of the meter device 8 and covers a display screen from above. The meter visor 41a functions as a visor to prevent external light from reflecting off the display screen and obscuring its visibility.

When the meter support configuration including the meter support part 41 and the meter visor 41a and the screen support configuration (the bracket 40) are separate from each other, a structure for connecting these two configurations is required. On the other hand, as in the embodiment, by integrally forming the meter support configuration with the bracket 40 of the screen support mechanism 35, a structure connecting the meter support configuration and the screen support configuration is not required, and both configurations can be arranged compactly.

### Windscreen 31

Referring to FIG. 2 and FIG. 3, the windscreen 31 is formed of, for example, a transparent resin material in a plate shape. The windscreen 31 has a shape gently bulging forward and upward from the vehicle, in accordance with exterior appearance of the vehicle. The windscreen 31 controls a flow of traveling wind toward the driver when the motorcycle 1 is traveling forward.

Referring to FIG. 2, the windscreen 31 has an upper edge portion 31a extending substantially horizontally when seen in a front view in the forward/rearward direction, left and right side edge portions 31b extending downward from left and right end portions of the upper edge portion 31a, and a lower edge portion 31c that bridges between lower end portions of the left and right side edge portions 31b. Each of the left and right side edge portions 31b is formed in a shallow V shape protruding outward in the vehicle leftward/rightward direction when seen in a front view. The lower edge portion 31c is formed in a curved shape protruding downward when seen in a front view. The windscreen 31 is formed laterally symmetrically using a lateral centerline CL of the vehicle body as the axis of symmetry.

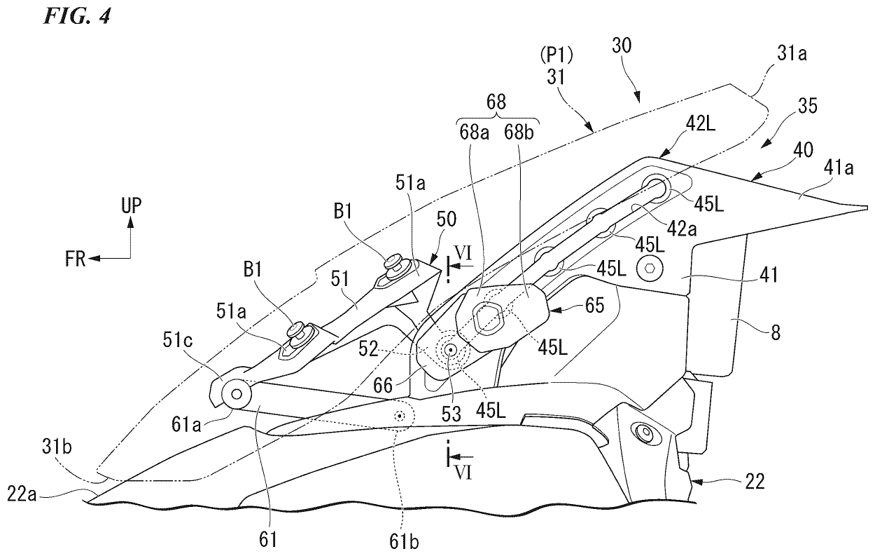

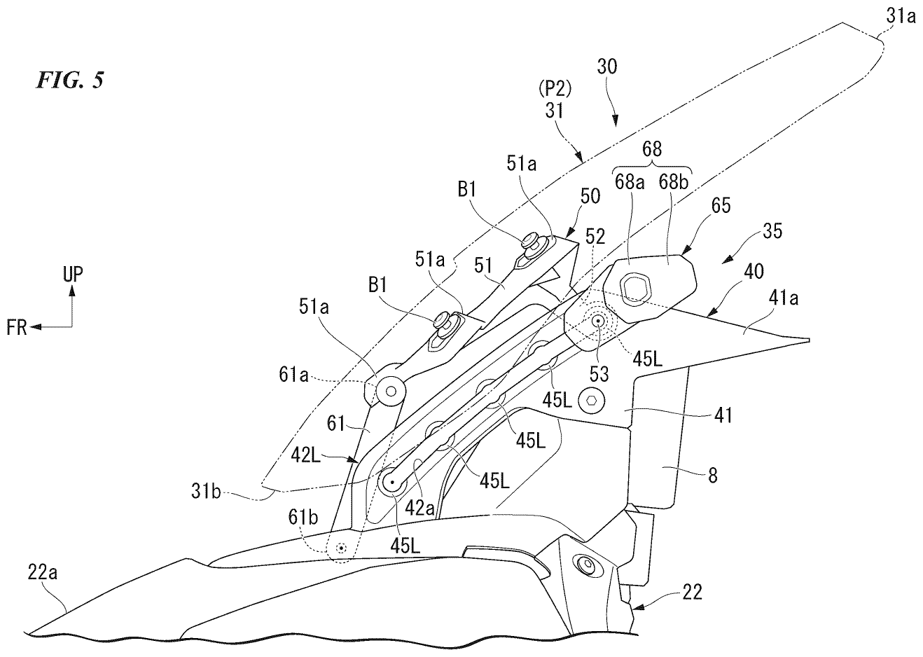

FIG. 4 is a left side view when the windscreen 31 is located at a lower limit position P1, and FIG. 5 is a left side view when the windscreen 31 is located at an upper limit position P2.

The windscreen 31 is supported by the screen support mechanism 35 to allow height adjustment relative to the vehicle body. The windscreen 31 is bidirectionally movable between the lower limit position P1 shown in FIG. 4 and the upper limit position P2 shown in FIG. 5 by an operation of the screen support mechanism 35.

The windscreen 31 located at the lower limit position P1 is disposed to be inclined along a front upper surface 22a inclined rearward and upward in the front body cover 22 when seen in a side view. The front lower end portion (the lower edge portion 31c) of the windscreen 31 located at the lower limit position P1 is separated upward and rearward from an upper edge 24a of a headlight 24 (see FIG. 2). Accordingly, the windscreen 31 is prevented from affecting a light distribution of the headlight 24. The front lower end portion of the windscreen 31 located at the lower limit position P1 is spaced further outward (forward and upward) from the vehicle than the front upper surface 22a of the front body cover 22. Accordingly, some of traveling wind can be introduced between the windscreen 31 and the front body cover 22. A rear upper end portion of the windscreen 31 located at the lower limit position P1 is located above the meter visor 41a.

The windscreen 31 at the upper limit position P2 is moved rearward and upward so that the front lower end portion is aligned with the front upper surface 22a of the front body cover 22 more than when it is at the lower limit position P1, and is positioned so that it is inclined more steeply toward the rear and rises higher than when it is at the lower limit position P1.

A front lower end portion of the windscreen 31 at the upper limit position P2 is disposed upward until the front lower portion of the bracket 40 of the screen support mechanism 35 is exposed. The front lower end portion of the windscreen 31 at the upper limit position P2 is spaced further outward (forward and upward) from the vehicle than the front body cover 22 and the bracket 40. Accordingly, like when the windscreen 31 is located at the lower limit position P1, some of the traveling wind can be introduced between the windscreen 31 and the front body cover 22. The rear upper end portion of the windscreen 31 at the upper limit position P2 moves upward more than when it is at the lower limit position P1, further reducing the amount of traveling wind toward the driver.

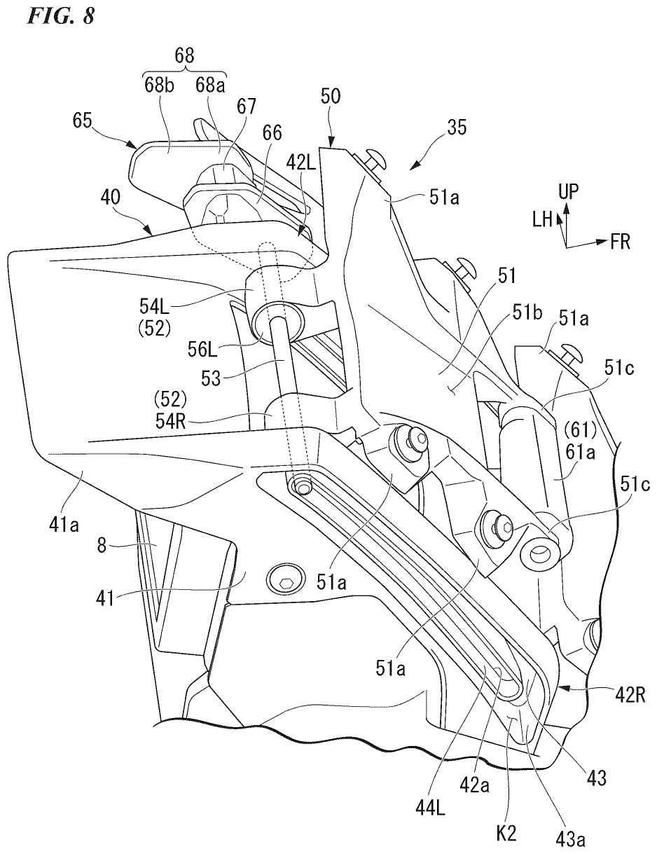

FIG. 8 is a perspective view of the screen support mechanism 35.

Referring to FIG. 3 and FIG. 8, fastening concave portions 32 fastened and fixed to four support arm portions 51a of the holder 50 are formed on both left and right sides of an intermediate portion of the windscreen 31 in the upward/downward direction. Each of the fastening concave portions 32 causes a corresponding area of the windscreen 31 to be recessed inward (rearward and downward) of the vehicle in a normal direction of the outer surface of the windscreen 31. Each of the fastening concave portions 32 is circular when viewed in the normal direction, and has a bolt insertion hole formed in the center portion. Each of the fastening concave portions 32 causes recess of a head portion of a fixing bolt B1 that screws into each of the support arm portions 51a of the holder 50.

Referring also to FIG. 2, an traveling wind intake part 33 having an inverted trapezoidal shape when seen in the forward/rearward direction is formed in a center portion in the vehicle leftward/rightward direction of a lower portion (an area below a center in the upward/downward direction center) of the windscreen 31. The traveling wind intake part 33 forms an inclined surface 33a that is inclined so that a depth toward the inside (rearward and downward) of the vehicle increases toward the upper end of the inverted trapezoidal shape, and the upper end portion forms an elongated air outlet 33b that penetrates in the forward/rearward direction. The air outlet 33b is disposed at a position overlapping with an air guide duct 51b (described later) on the inside of the holder 50 in the vehicle leftward/rightward direction when viewed in the forward/rearward direction.

### Screen Support Mechanism 35

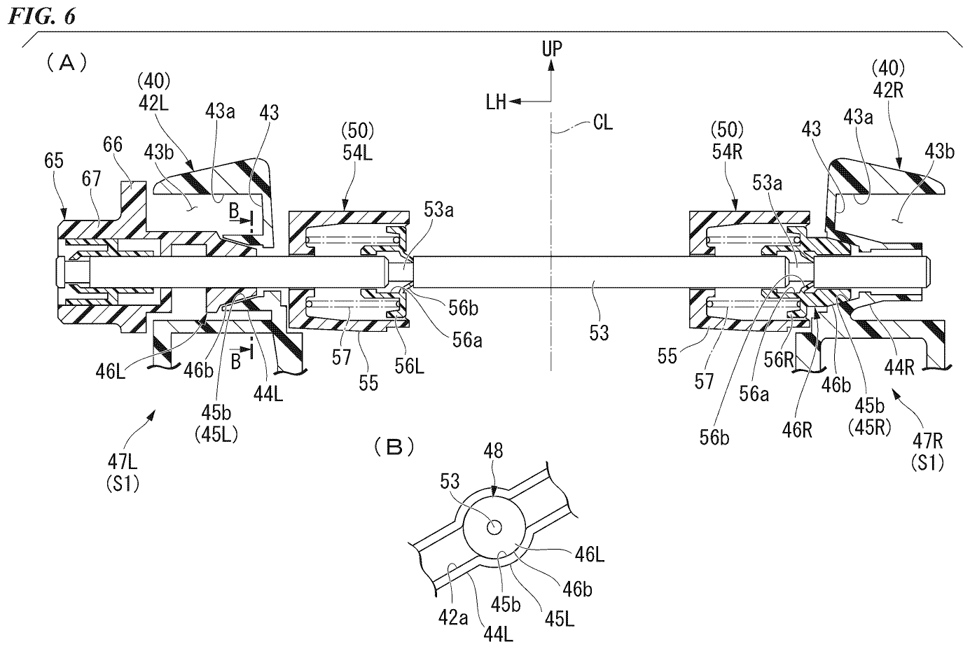

FIG. 6(A) is a cross-sectional view along line VI-VI of FIG. 4. Referring to FIG. 4, FIG. 6(A) and FIG. 8, the screen support mechanism 35 includes the bracket 40 fixed to the vehicle body, the holder 50 movably supported on the bracket 40, and the windscreen 31 attached to the holder 50. Each of the bracket 40 and the holder 50 is formed of, for example, a synthetic resin.

The holder 50 includes a plate-shaped holder main body portion 51 disposed behind and below the windscreen 31 (inner surface side, vehicle body side), and a pair of left and right arm portions 52 extending rearward and downward from a vehicle body side of the upper portion of the holder main body portion 51. The holder main body portion 51 is disposed to be inclined rearward and upward along an inner surface (back surface) of the windscreen 31 when seen in a side view. The tip portions (rear lower end portions) of the left and right arm portions 52 are provided with left and right shaft holding parts 54L and 54R (first connecting parts) that pass through and hold left and right side portions of a shaft 53 extending along the vehicle leftward/rightward direction in the vehicle leftward/rightward direction.

Referring to FIG. 6(A), the left and right shaft holding parts 54L and 54R hold the shaft 53 so that it cannot move relative to one another when seen in the vehicle leftward/rightward direction. The left and right shaft holding parts 54L and 54R allows movement and rotation in an axial direction of the shaft 53. The left and right shaft holding parts 54L and 54R includes bottomed cylindrical cup portions 55 that open toward the other side (right side) in the vehicle leftward/rightward direction, spring seats 56L and 56R disposed to close the opening portions of the cup portions 55, and coil springs 57 compressively provided between bottom portions of the cup portions 55 and the spring seats 56L and 56R, respectively.

Each of the spring seats 56L and 56R has an insertion hole 56a through which the shaft 53 is inserted, and an elastic piece 56b (locking claw) extending to be inclined toward the other side (right side) in the vehicle leftward/rightward direction on an inner circumferential side of the insertion hole 56a. The spring seats 56L and 56R engage with cutout portions 53a that are partially formed in the outer circumference of the shaft 53 by inserting the elastic pieces 56b into them. Accordingly, rightward movement of the spring seats 56L and 56R with respect to the shaft 53 is restricted. A biasing force of the coil spring 57 is applied rightward to the spring seats 56L and 56R, and the shaft 53 is biased rightward together with the spring seats 56L and 56R.

Referring to FIG. 4 and FIG. 8, the support arm portions 51a extending toward the inner surface (back surface) of the windscreen 31 are formed on four corners of the rectangular holder main body portion 51. The support arm portions 51a extend diagonally forward and outward to the left and right from the four corners of the holder main body portion 51, respectively. The front upper surface portion of the holder main body portion 51 forms the air guide duct 51b recessed downward and rearward between the left and right support arm portions 51a.

The air guide duct 51b faces the air outlet 33b of the windscreen 31. The air guide duct 51b guides the traveling wind introduced from the air outlet 33b to the back surface of the windscreen 31 while straightening it rearward and upward. The air guide duct 51b opens to the front lower end of the holder 50. The air guide duct 51b guides some of the traveling wind that is introduced from the front lower end of the windscreen 31 to between the windscreen 31 and the front body cover 22 while straightening it rearward and upward.

The front end portion of the holder 50 and the front end portion of the bracket 40 are connected via a link member 61. One end portion 61a of the link member 61 is relatively rotatably connected to a link connecting portion 51c extending forward and downward from the front end portion of the holder main body portion 51 via a shaft extending in the vehicle leftward/rightward direction. The other end portion 61b of the link member 61 is relatively rotatably connected to the front end portion of the bracket 40 via a shaft extending in the vehicle leftward/rightward direction.

When the windscreen 31 is located at the lower limit position P1, the link member 61 is disposed to extend substantially horizontally forward from the side of the bracket 40 (specifically, inclined substantially forward and upward). As the windscreen 31 rises from the lower limit position Pl towards the upper limit position P2, the link member 61 rotates upward and forward around the other end portion 61b, causing the one end portion 61a to follow the upward movement of the windscreen 31. When the windscreen 31 reaches the upper limit position P2, the link member 61 is disposed so as to extend upward generally vertically from the bracket 40 side (see FIG. 5).

The bracket 40 includes a base part (not shown) fixed to at least one of the front body cover 22 and a support stay (not shown) fixed to the vehicle body frame 11 inside the front body cover 22, and a pair of left and right slide groove forming parts 42L and 42R (second connecting parts) extending to be inclined from both left and right sides of the base part toward a rear upper side when seen in a side view and configured to slidably support the holder 50.

Referring also to FIG. 6(A), the left and right slide groove forming parts 42L and 42R are formed symmetrically on the left and right sides with the centerline CL in the vehicle leftward/rightward direction as the axis of symmetry. The left and right slide groove forming parts 42L and 42R are formed in an arc shape protruding forward and upward when seen in a side view. The left and right slide groove forming parts 42L and 42R have slide grooves 42a extending to be inclined and curved along the left and right slide groove forming parts 42L and 42R when seen in a side view. The slide grooves 42a penetrate the corresponding slide groove forming part over their entire length in the vehicle leftward/rightward direction. While the slide grooves 42a are inclined and curved to be located rearward as they go upward when seen in a side view, the slide grooves 42a extend in the upward/downward direction without folding back in the upward/downward direction from one end to the other end in the groove length direction.

The left and right slide groove forming parts 42L and 42R connect the left and right shaft holding parts 54L and 54R of the holder 50 via left and right side portions of the shaft 53, respectively. The left and right slide groove forming parts 42L and 42R allow the left and right shaft holding parts 54L and 54R of the holder 50 to slide in the groove length direction of the slide grooves 42a, respectively. By sliding the left and right shaft holding parts 54L and 54R in the upward/downward direction along the left and right slide grooves 42a, the windscreen 31 can be raised and lowered (height is adjustable) together with the holder 50.

The left and right slide groove forming parts 42L and 42R form the slide grooves 42a in an inner sidewall 43 located at an inner side in the vehicle leftward/rightward direction. The inner sidewall 43 has an external form slightly greater than the slide grooves 42a when seen in a side view. An outer circumferential wall 43a extends from an outer circumferential edge of the inner sidewall 43 toward an outer sidewall of the corresponding slide groove forming part on an outer side in the vehicle leftward/rightward direction. Parts of lock actuating parts 47L and 47R, which will be described below, are accommodated in a concave space 43b surrounded by the outer circumferential wall 43a and the inner sidewall 43. Left and right guide walls 44L and 44R are formed on the outer side of the inner sidewall 43 in the leftward/rightward direction of the vehicle, extending from the outer circumferential edge of the slide grooves 42a, when seen in a side view, toward the outer side in the vehicle leftward/rightward direction (inside the concave space 43b).

When seen in a side view, fitting concave portions 45L and 45R are formed at a plurality of places at intervals in the groove length direction of the slide grooves 42a in the left and right guide walls 44L and 44R, respectively, which are formed to partially expand the lateral grooves of the slide grooves 42a. Each of the fitting concave portions 45L and 45R forms a space wider than the slide grooves 42a in the lateral groove direction of the slide grooves 42a. Each of the fitting concave portions 45L of the left slide groove forming part 42L can be fitted with the left fitting member 46L from the left side (outside the vehicle leftward/rightward direction), and each of the fitting concave portions 45R of the right slide groove forming part 42R can be fitted with the right fitting member 46R from the left side (inside the vehicle leftward/rightward direction).

The left and right slide groove forming parts 42L and 42R are respectively provided with the pair of left and right fitting members 46L and 46R, which are supported by the left and right side portions of the shaft 53 and can move integrally with the shaft 53 in the vehicle leftward/rightward directions.

The left fitting member 46L is disposed on the left side (outside the vehicle leftward/rightward direction) of the inner sidewall 43 within the concave space 43b of the left slide groove forming part 42L, and is capable of being engaged with and disengaged from the left side (outside the vehicle leftward/rightward direction) of the plurality of fitting concave portions 45L formed in the left guide wall 44L.

The right fitting member 46R is disposed on the left side (inside the vehicle leftward/rightward direction) of the inner sidewall 43 of the right slide groove forming part 42R, and is capable of being engaged with and disengaged from the left side (inside the vehicle leftward/rightward direction) of the plurality of fitting concave portions 45R formed in the right guide wall 44R.

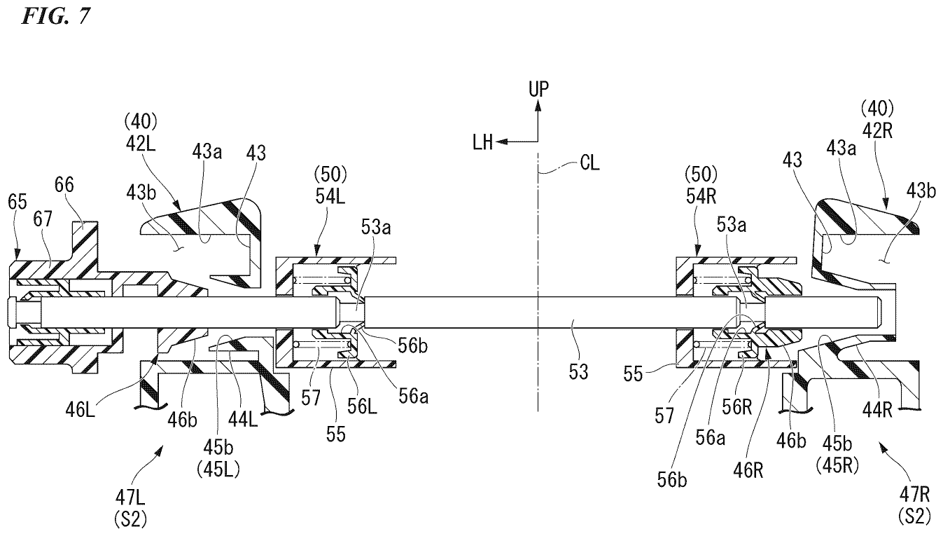

The combination of the left fitting member 46L and the left fitting concave portion 45L, and the combination of the right fitting member 46R and the right fitting concave portion 45R constitute the pair of left and right lock actuating parts 47L and 47R. The left and right lock actuating parts 47L and 47R are switchable between a locked state S1 in which the shaft holding part on the same side is engaged with the left and right slide groove forming parts 42L and 42R so as to be unable to slide, and a lock released state S2 (see FIG. 7) in which the shaft holding part on the same side is able to slide with respect to the left and right slide groove forming parts 42L and 42R.

The shaft 53 is a steel member with a circular cross-section that extends across the entire lateral width of the screen support mechanism 35, and the left and right side portions of the shaft 53 penetrate the left and right shaft holding parts 54L and 54R and the left and right slide groove forming parts 42L and 42R, respectively. The shaft 53 connects the shaft holding part and the slide groove forming part on the same left and right sides of the screen support mechanism 35 so that they can rotate relatively around the center of the shaft 53.

The left side portion of the shaft 53 protrudes to the left through the shaft holding part 54L of the left arm portion 52, passes through a predetermined position in the groove length direction of the slide grooves 42a of the left slide groove forming part 42L, and protrudes further leftward. The left side portion of the shaft 53 passes through the left fitting member 46L within the concave space 43b of the left slide groove forming part 42L, and is further inserted into the operating part 65 disposed outside the left slide groove forming part 42L in the vehicle leftward/rightward direction. The left end portion of the shaft 53 is, for example, a screw shaft with a screw thread formed thereon, and the operating part 65 is fixed to the left end portion by a fastening structure using a nut or the like. In the embodiment, the left fitting member 46L is integrated into the inside of the operating part 65 in the vehicle leftward/rightward direction, allowing the operating part 65, the left fitting member 46L and the shaft 53 to move integrally in the vehicle leftward/rightward direction. Further, the operating part 65 and the left fitting member 46L may be configured separately.

The right side portion of the shaft 53 passes through the shaft holding part 54R of the right arm portion 52, protrudes rightward, passes through a predetermined position in the groove length direction of the slide grooves 42a of the right slide groove forming part 42R, and protrudes further rightward. The right side portion of the shaft 53 passes through the right fitting member 46R, which is disposed on the left side (inside the vehicle leftward/rightward direction) of the inner sidewall 43 of the right slide groove forming part 42R. The right guide wall 44R extends close to the right end of the concave space 43b of the right slide groove forming part 42R. The right end portion of the shaft 53 extends to the vicinity of the right end of the right guide wall 44R (more specifically, between the right end of the right guide wall 44R and the right end of the concave space 43b).

In the embodiment, the right fitting member 46R is integrated with the right side of the right spring seat 56R, and the right fitting member 46R is biased rightward by the right coil spring 57. When the operating part 65 and the shaft 53 are moved leftward, the right spring seat 56R and the right fitting member 46R can be moved leftward against the biasing force of the right coil spring 57. Further, the right spring seat 56R and the right fitting member 46R may be configured separately.

The operating part 65 is fixed to one end portion (in the embodiment, a left end portion) of the shaft 53 in the vehicle leftward/rightward direction. The operating part 65 is provided only on the left side of the shaft 53, and not provided on the right side of the shaft 53. The operating part 65 and the shaft 53 are movable to one side (left side) in the vehicle leftward/rightward direction by a prescribed amount in the axial direction (vehicle leftward/rightward direction). The shaft 53 and the left and right fitting members 46L and 46R are movable in the vehicle leftward/rightward direction by the operation to the operating part 65 and the release thereof, and the locked state S1 and the lock released state S2 (see FIG. 7) of the left and right lock actuating parts 47L and 47R can be simultaneously switched by the movement. Details of the operating part 65 will be described below.

FIG. 7 is the same cross-sectional view as FIG. 6(A), and shows the lock released state S2 of the left and right lock actuating parts 47L and 47R.

Referring to FIG. 6(A), the left and right lock actuating parts 47L and 47R are respectively placed in the locked state S1 by moving the left and right fitting members 46L and 46R to the other side in the vehicle leftward/rightward direction (the right side, the opposite side to the operating part 65 on the shaft 53).

Referring to FIG. 7, the left and right lock actuating parts 47L and 47R are respectively placed in the lock released state S2 by moving the left and right fitting members 46L and 46R to one side in the vehicle leftward/rightward direction (the left side, the side of the operating part 65 on the shaft 53).

The shaft 53 and the left and right fitting members 46L and 46R are biases rightward by the coil spring 57 with respect to the left and right shaft holding parts 54L and 54R, respectively. Accordingly, the operating part 65 is operated to be pulled leftward against the biasing force of the right coil spring 57.

When the height of the windscreen 31 is adjusted, first, the user pulls the operating part 65 on the left side of the shaft 53 leftward, and releases the locked state S1 of the left and right lock actuating parts 47L and 47R. In the embodiment, by operating the operating part 65 provided on one side of the shaft 53 in the vehicle leftward/rightward direction, the locked state S1 of the lock actuating parts 47L and 47R on both the left and right sides can be released simultaneously, making the lock release operation of the left and right lock actuating parts 47L and 47R easier than in a configuration in which the operating parts are provided on both the left and right sides and operated. The occupant can generally operate the brake lever supported on the right side of the handle 2 and the operating part 65 with his/her left hand.

The user pulls the operating part 65 to the left, and pulls the shaft 53, and the left and right fitting members 46L and 46R to the left together with the operating part 65, thereby sliding the operating part 65, the shaft 53, and the left and right fitting members 46L and 46R along the left and right slide grooves 42a, while maintaining the lock released state S2. Then, the left and right shaft holding parts 54L and 54R, which coaxially hold the shaft 53, slide along the left and right slide grooves 42a, causing the upper portion of the holder 50 and the vertical intermediate portion of the windscreen 31 to move along the left and right slide grooves 42a. Here, the lower portion of the holder 50 and the lower portion of the windscreen 31 move along the pivot trajectory of the link member 61, causing the holder 50 and the windscreen 31 to move in the upward/downward direction while tilting overall.

When the windscreen 31 reaches the desired height, if the user releases the operation of pulling the operating part 65 to the left, the left and right fitting members 46L and 46R move to the right due to the biasing force of the left and right coil springs 57. Here, when the left and right fitting members 46L and 46R are at a position that overlaps with any fitting concave portion when seen in a side view, the left and right fitting members 46L and 46R will fit into the corresponding fitting concave portion. Accordingly, the left and right lock actuating parts 47L and 47R return to the locked state S1, the windscreen 31 is fixed at the desired height and the screen height adjustment is complete. By performing this series of operations using the operating part 65 located on either the left or right side of the shaft 53, screen height adjustment can be made easily.

Here, the engagement structure between the cutout portion 53a of the shaft 53 and each of the spring seats 56L and 56R restricts the rightward movement of each of the spring seats 56L and 56R relative to the shaft 53, while allowing each of the spring seats 56L and 56R to move to the left relative to the shaft 53 by only a prescribed amount. For this reason, if the left and right lock actuating parts 47L and 47R, for example, even if the right fitting member 46R id first fully fitted into the fitting concave portion 45R, after that, it is possible to move the shaft 53 and the left fitting member 46L further to the right relative to the right spring seat 56R, and it is possible to fit the left fitting member 46L. In this way, even if there is variation in the lock positions of the left and right lock actuating parts 47L and 47R, the left and right lock actuating parts 47L and 47R can be reliably placed in the locked state S1.

FIG. 6(B) is a cross-sectional view along line B-B in FIG. 6(A).

Referring to FIG. 6(A) and FIG. 6(B), at least one of the left and right lock actuating parts 47L and 47R (in the embodiment, both the left and right lock actuating parts 47L and 47R) has a rotation restriction structure 48 configured to restrict rotation of the operating part 65 about the shaft 53 in the locked state S1. The rotation restriction structure 48 is realized by a cross-sectional shape perpendicular to the axial direction of the shaft 53 in the fitting members 46L and 46R and the fitting concave portions 45L and 45R.

In the rotation restriction structure 48 of the embodiment, while the cross-sectional shapes of the fitting members 46L and 46R and the fitting concave portions 45L and 45R are perfect circles that match each other, by fitting the fitting members 46L and 46R and the fitting concave portions 45L and 45R to each other, rotation of the operating part 65 about the shaft 53 in the locked state S1 is restricted. FIG. 6(B) shows the configuration of the left lock actuating part 47L, but the right lock actuating part 47R has also a similar configuration.

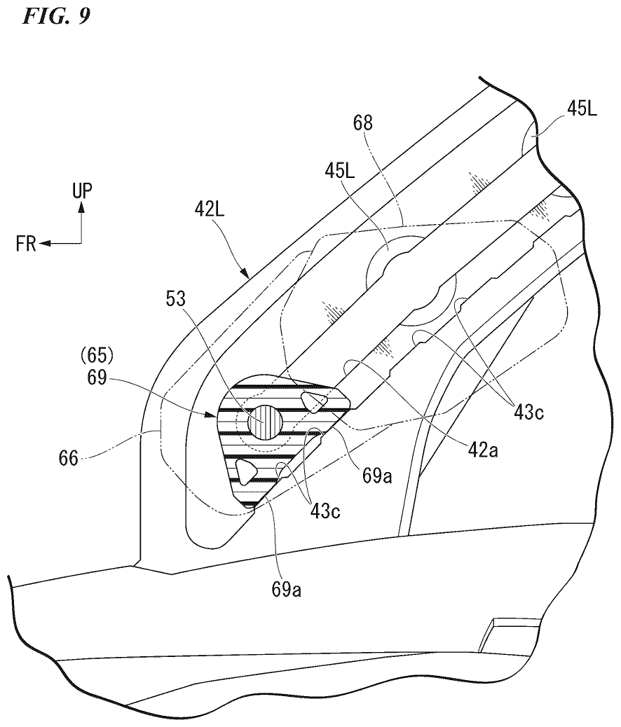

FIG. 9 is a left side view showing a structure for removing rattling in a rotation direction of the operating part 65 of the screen support mechanism 35.

Referring to FIG. 9, a sliding portion 69 having a substantially triangular shape that fits into the outer circumferential wall 43a of the left slide groove forming part 42L is provided inside the operating part 65 in the vehicle width direction. The sliding portion 69 includes a pair of sliding contact portions 69a that are in sliding contact with the outer circumferential wall 43a on a rear lower side (curved inner circumferential side) of the left slide groove forming part 42L. The outer circumferential wall 43a is formed with a pedestal 43c on which each of the sliding contact portions 69a rides at positions where the fitting members 46L and 46R and the fitting concave portions 45L and 45R fit together. In the lock released state S2, the operating part 65 is movable along the left slide groove forming part 42L with a certain degree of play in which rotation is restricted. When the operating part 65 is in the prescribed position, each of the sliding contact portions 69a rides up onto the corresponding pedestal 43c, thereby achieving rattling removal in the rotation direction. In this state, the left and right lock actuating parts 47L and 47R can be set to the locked state S1.

Referring to FIG. 6(A) and FIG. 7, at least one of the outer circumferential surface (first fitting surface) fitted into the fitting concave portions 45L and 45R in the fitting members 46L and 46R and the inner circumferential surface (second fitting surface) fitted onto the fitting members 46L and 46R in the fitting concave portions 45L and 45R (in the embodiment, both the first fitting surface and the second fitting surface) becomes tapered surfaces 45b and 46b, which have a cross-sectional shape that is smaller on the other side in the vehicle leftward/rightward direction.

Accordingly, when returning the lock actuating parts 47L and 47R from the lock released state S2 to the locked state S1, even if the relative positions of the fitting members 46L and 46R and the fitting concave portions 45L and 45R are slightly misaligned when seen in a side view, once the tip portions of the fitting members 46L and 46R are inserted into the fitting concave portions 45L and 45R, they are guided by the tapered surfaces 45b and 46b, and the misalignment of the relative positions of the fitting members 46L and 46R and the fitting concave portions 45L and 45R is eliminated (returned to the correct relative positions), allowing the fitting members 46L and 46R and the fitting concave portions 45L and 45R to be fitted. The tapered surfaces 45b and 46b have a small inclined angle with respect to the axial direction, and the wedge effect of the tapered surfaces 45b and 46b allows the fitting members 46L and 46R and the fitting concave portions 45L and 45R to be reliably fitted together with limited biasing force without rattling.

Referring to FIG. 6(A) and FIG. 8, the operating part 65 includes a base portion 66 formed in a plate shape perpendicular to the axial direction of the shaft 53 and directly fixed to one end portion (left end portion) of the shaft 53 in the vehicle leftward/rightward direction, a protrusion 67 protruding outward from the rear portion of the base portion 66 in the vehicle leftward/rightward direction, and a grip portion 68 formed in a plate shape perpendicular to the axial direction of the shaft 53 and fixed to an outer end portion of the protrusion 67 in the vehicle leftward/rightward direction.

The base portion 66 forms an ellipse that is long in the forward/rearward direction when seen in axial direction of the shaft 53 (i.e., when seen in a side view). The base portion 66 fixes the left end portion of the shaft 53 to the inside of the front portion in the vehicle leftward/rightward direction, and has the protrusion 67 protruding to the outside of the rear portion, which is located behind the shaft 53 in the vehicle leftward/rightward direction. The center of the front arc shape of the base portion 66, when seen in a side view, is disposed on an extension of the left end portion of the shaft 53.

The protrusion 67 is, for example, a hollow cylinder with its axial direction oriented in the vehicle leftward/rightward direction, and is disposed coaxially with the arc-shaped rear side of the base portion 66 when seen in a side view. The protrusion 67 extends leftward (outward in the vehicle leftward/rightward direction) from the rear portion of the base portion 66.

The grip portion 68 forms a long oval shape in the forward/rearward direction when seen in a side view. The grip portion 68 includes a base portion 68a that is within the range of the base radius from the axial center of the protrusion 67 when seen in the axial direction of the shaft 53, and an extension portion 68b that extends rearward beyond the base radius from the axial center of the protrusion 67.

The grip portion 68 is offset further outward in the vehicle leftward/rightward direction than the base portion 66 adjacent to the left slide groove forming part 42L, and extends further rearward (toward the occupant) than the base portion 66. Accordingly, the grip portion 68 protrudes outward in the vehicle leftward/rightward direction more than the base portion 66 adjacent to the left slide groove forming part 42L, and is generally located behind the shaft 53. For this reason, the grip portion 68 is easily visible and grasped by the occupant, improving ease of operation of the screen height adjustment. When the grip portion 68 is disposed to overlap with the shaft 53 when seen in a side view, the area located behind the shaft 53 has an aspect that extends significantly rearward relative to the area located in front of the shaft 53.

The extension portion 68b of the grip portion 68 is tapered so that a vertical width narrows toward the rear when seen in a side view. Accordingly, while maintaining the size of the grip portion 68 when seen in a side view, the degree of freedom of the angle of the hand holding the grip portion 68 is increased. The extension portion 68b is tapered toward the rear in a plan view so as to narrow the width in the vehicle leftward/rightward direction, which also increases the degree of freedom of the grasping hand angle.

As described above, the windscreen device 30 according to the embodiment includes the windscreen 31, the holder 50 configured to support the windscreen 31, the bracket 40 configured to vertically movably support the holder 50 together with the windscreen 31 and fixed to the vehicle body, and the shaft 53 extending in the vehicle leftward/rightward direction and configured to pass through and connect the first connecting part (the shaft holding parts 54L and 54R) of the holder 50 and the second connecting part (the slide groove forming parts 42L and 42R) of the bracket 40 in the vehicle leftward/rightward direction, one of the first connecting part and the second connecting part is the shaft holding parts 54L and 54R, which hold the shaft 53 so that it cannot move relatively when seen in the vehicle leftward/rightward direction, the other of the first connecting part and the second connecting part is the slide groove forming parts 42L and 42R that form the slide grooves 42a extending in the vehicle upward/downward direction and allow the shaft holding parts 54L and 54R to slide in the groove length direction of the slide grooves 42a, the height of the windscreen 31 is adjustable together with the holder 50 by sliding the shaft holding parts 54L and 54R along the slide grooves 42a, the fitting members 46L and 46R supported on the shaft 53 and movable in the vehicle leftward/rightward direction integrally with the shaft 53 are disposed in the slide groove forming parts 42L and 42R, the fitting concave portions 45L and 45R configured to partially expand the lateral groove to allow the fitting members 46L and 46R to be fitted thereinto are formed at the plurality of places at intervals in the groove length direction of the slide grooves 42a, the fitting members 46L and 46R and the fitting concave portions 45L and 45R constitute the lock actuating parts 47L and 47R that switch between the locked state S1 in which the shaft holding parts 54L and 54R are unable to slide with respect to the slide groove forming parts 42L and 42R and the lock released state S2 in which the shaft holding parts 54L and 54R is able to slide with respect to the slide groove forming parts 42L and 42R, the operating part 65 configured to move the shaft 53 and the fitting members 46L and 46R in the vehicle leftward/rightward direction and switchable between the locked state S1 and the lock released state S2 of the lock actuating parts 47L and 47R is provided on the shaft 53, and the operating part 65 is provided only one side of the shaft 53 in the vehicle leftward/rightward direction.

According to this configuration, by providing the operating part 65 configured to switch the locking and unlocking of the lock actuating parts 47L and 47R only on one side of the shaft 53 configured to connect the holder 50 supporting the windscreen 31 and the bracket 40 fixed to the vehicle body in the vehicle leftward/rightward direction, the occupant (user) can perform height adjustment of the windscreen 31 with one hand. For this reason, compared with the case where the lock and unlock switching of the lock actuating parts 47L and 47R is performed using the operating part 65 on both the left and right sides, this makes it easier to operate the height adjustment and achieves reduction in the number of parts.

In the windscreen device 30, the lock actuating parts 47L and 47R are provided as a pair on the left and right, and the states of the pair of left and right lock actuating parts 47L and 47R can be switched simultaneously by the operating part 65 on one of the left and right sides.

According to this configuration, by simultaneously switching the locking and unlocking of the pair of left and right lock actuating parts 47L and 47R by operating the operating part 65 on one side in the vehicle leftward/rightward direction, height adjustment of the windscreen 31 can be performed stably by the pair of left and right lock actuating parts 47L and 47R, while allowing height adjustment of the windscreen 31 with one-handed operation.

In the windscreen device 30, the lock actuating parts 47L and 47R move the fitting members 46L and 46R to the other side in the vehicle leftward/rightward direction to enter the locked state S1, and move the fitting members 46L and 46R to one side in the vehicle leftward/rightward direction to enter the lock released state S2, and the fitting members 46L and 46R are biased to the other side in the vehicle leftward/rightward direction by the elastic member (the coil spring 57).

According to this configuration, as the fitting members 46L and 46R of the lock actuating parts 47L and 47R are biased toward the other side (lock side) in the vehicle leftward/rightward direction by the coil spring 57, after the operating part 65 is operated to one side (unlock side) in the vehicle leftward/rightward direction to perform screen height adjustment, the lock actuating parts 47L and 47R can be returned to the locked state S1 by simply releasing the operating part 65, making height adjustment of the windscreen 31 easier.

In the windscreen device 30, at least one of the first fitting surface (46b) that fits into the fitting concave portions 45L and 45R in the fitting members 46L and 46R, and the second fitting surface (45b) that fits into the fitting members 46L and 46R in the fitting concave portions 45L and 45R, is made to have the tapered surfaces 45b and 46b that reduce in a cross-sectional shape toward the other side in the vehicle leftward/rightward direction.

According to this configuration, at least one fitting surface of the fitting members 46L and 46R and the fitting concave portions 45L and 45R is tapered to the tapered surfaces 45b and 46b, so that even if the relative positions of the fitting members 46L and 46R and the fitting concave portions 45L and 45R are slightly misaligned, the fitting members 46L and 46R and the fitting concave portions 45L and 45R can be guided to the prescribed relative positions by the tapered surfaces 45b and 46b. In addition, when the fitting members 46L and 46R are biased in a fitting direction, the wedge effect of the tapered surfaces 45b and 46b allows the fitting members 46L and 46R and the fitting concave portions 45L and 45R to fit reliably without rattling, even with limited biasing force. For this reason, the screen height adjustment can be further facilitated.

In the windscreen device 30, the operating part 65 has the grip portion 68 which extends rearward from the shaft 53 when seen in the axial direction of the shaft 53.

According to this configuration, as the operating part 65 has the grip portion 68 extending rearward from the shaft 53, since the grip portion 68 can be easily seen and reached from the rear (occupant side) of the operating part 65, the operability of the operating part 65 can be improved.

In the windscreen device 30, the operating part 65 has the grip portion 68 offset outward in the vehicle leftward/rightward direction from the base portion 66 which fixes the end portion of the shaft 53.

According to this configuration, by providing the operating part 65 with the grip portion 68 that is offset further outward in the vehicle leftward/rightward direction than the end portion of the shaft 53, it is easier to ensure clearance for the hand to reach inside the vehicle leftward/rightward direction of the grip portion 68 regardless of the position in the vehicle leftward/rightward direction of the end portion of the shaft 53, thereby improving the operability of the operating part 65.

In the windscreen device 30, the lock actuating parts 47L and 47R have the rotation restriction structure 48 configured to restrict the rotation of the operating part 65 about the shaft 53 in the locked state S1.

According to this configuration, the lock actuating parts 47L and 47R have the rotation restriction structure 48 configured to restrict the rotation angle of the operating part 65 in the locked state S1, so that the rotation angle of the operating part 65 after the screen height adjustment (the locked state S1) can be adjusted to a predetermined desired angle. For this reason, after the screen height adjustment, the operating part 65 can be maintained at a comfortable angle.

The present invention is not limited to the above-mentioned embodiment, and may be configured, for example, such that the holder 50 has the slide groove forming part and the bracket 40 has the shaft holding part.

The windscreen device 30 of the embodiment may be applied to a saddle riding vehicle other than the motorcycle. The saddle riding vehicle includes all vehicles in which the driver straddles the vehicle body, including motorcycles (including bicycles with prime movers and scooter-type vehicles), as well as vehicles with three wheels (including vehicles with one wheel in front and two wheels in the rear, as well as vehicles with two wheels in front and one wheel in the rear) or four wheels (such as four-wheeled buggies). In addition, this includes not only vehicles with straddle sections, but also vehicles without straddle sections.

The configuration of the above-mentioned embodiment is one example of the present invention, and various modifications are possible without departing from the spirit of the present invention, such as replacing the components of the embodiment with well-known components.

### BRIEF DESCRIPTION OF THE REFERENCE SYMBOLS

1 Motorcycle (saddle riding vehicle)
30 Windscreen device
31 Windscreen
40 Bracket
42a Slide groove
42L, 42R Second connecting part, slide groove forming part
45b Second fitting surface, tapered surface
45L, 45R Fitting concave portion
46b First fitting surface, tapered surface
46L, 46R Fitting member
47L, 47R Lock actuating part
48 Rotation restriction structure
50 Holder
53 Shaft
54L, 54R First connecting part, shaft holding part
57 Coil spring (elastic member)
65 Operating part
66 Base portion
68 Grip portion
S1 Lock state
S2 Lock released state

1. A windscreen device comprising:
a windscreen;
a holder configured to support the windscreen;
a bracket configured to vertically movably support the holder together with the windscreen and fixed to a vehicle body; and
a shaft extending in a vehicle leftward/rightward direction and configured to pass through and connect first connecting parts of the holder and second connecting parts of the bracket in the vehicle leftward/rightward direction,
wherein one of the first connecting parts and the second connecting parts is shaft holding parts configured to relatively immovably hold the shaft when seen in the vehicle leftward/rightward direction,
the other of the first connecting parts and the second connecting parts is slide groove forming parts that form a slide groove extending in a vehicle upward/downward direction and allow the shaft holding parts to slide in a groove length direction of the slide groove,
a height of the windscreen is adjustable together with the holder by sliding the shaft holding parts along the slide groove,
the slide groove forming parts are provided with fitting members that are supported by the shaft and able to move integrally with the shaft in the vehicle leftward/rightward direction, and fitting concave portions that partially expand lateral grooves and allow the fitting members to fit are formed at a plurality of places at intervals in the groove length direction of the slide groove,
the fitting members and the fitting concave portions constitute lock actuating parts configured to switch between a locked state in which the shaft holding parts are unable to slide with respect to the slide groove forming parts and a lock released state in which the shaft holding parts are able to slide with respect to the slide groove forming parts,
the shaft is provided with an operating part configured to move the shaft and the fitting members in the vehicle leftward/rightward direction and switch between the locked state and the lock released state of the lock actuating parts, and
the operating part is provided only on one side of the shaft in the vehicle leftward/rightward direction.

2. The windscreen device according to claim 1, wherein the lock actuating parts are provided in pairs on the left and right, and
the operating part on one side of the left and right is able to switch states of a pair of left and right lock actuating parts simultaneously.

3. The windscreen device according to claim 1, wherein the lock actuating parts move the fitting members to the other side in the vehicle leftward/rightward direction to enter the locked state, and move the fitting members to one side in the vehicle leftward/rightward direction to enter the lock released state, and
the fitting members are biased toward the other side in the vehicle leftward/rightward direction by an elastic member.

4. The windscreen device according to claim 1, wherein at least one of a first fitting surface fitted into the fitting concave portions in the fitting members and a second fitting surface fitted onto the fitting members in the fitting concave portions becomes tapered surfaces that reduce a cross-sectional shape as they go toward the other side in the vehicle leftward/rightward direction.

5. The windscreen device according to claim 1, wherein the operating part includes a grip portion that extends rearward from the shaft when seen in an axial direction of the shaft.

6. The windscreen device according to claim 1, wherein the operating part includes a grip portion offset outward in the vehicle leftward/rightward direction with respect to a base portion configured to fix an end portion of the shaft.

7. The windscreen device according to claim 1, wherein the lock actuating parts have a rotation restriction structure configured to restrict rotation of the operating part about the shaft in the locked state.
